(19) United States
(12) Patent Application Publication
(10) Pub. No.: US 2015/0143668 A1
(43) Pub. Date: May 28, 2015

(54) Apparatus for a Door Frame Reinforcement and Method for Installing

(71) Applicant: MARTIN A. SOVIS, Flushing, MI (US)

(72) Inventor: MARTIN A. SOVIS, Flushing, MI (US)

(21) Appl. No.: 14/088,380

(22) Filed: Nov. 23, 2013

(51) Int. Cl. E05B 15/02; E05D 11/00

(52) U.S. Cl. CPC E05B 15/0205; E05D 11/00
USPC 16/402

(57) ABSTRACT

The invention provides a reinforcement for a door hingedly connected to a surrounding door frame mounted in a wall structure not normally made of 2×4 wall studs; said structures being smaller in thickness end depth such as in doors with sidelight glass. A male pin member, positioned within a recess drilled into either or both a hinge side and knob side of a door edge, extends laterally past the door edge surface. A receiving member mounted within a corresponding recess drilled within a door jamb includes a pin receiving portion and a reduced diameter reinforcing portion. The reduced diameter portion is tubular in shape to accept a threaded fastener entering through the receiving portion to secure the receiving member in position. The tubular reinforcing portion is of such length to enter the wall structure hot not break through an adjacent glass or panel.

### CROSS-REFERENCE TO RELATED APPLICATION

This non-provisional application claims priority to Provisional Patent Application 61/729,584 filed on Nov. 24, 2012 by Martin Anthony Sovis, 5279 Duffield Road, Flushing Mich. 48433-9786, the contents of which are hereby incorporated into this non-provisional application. Title of Provisional Application: Apparatus for a Door Frame Reinforcement and Method of Installing.

### STATEMENT REGARDING FEDERALLY SPONSORED RESEARCH OF DEVELOPMENT

“not applicable”

### REFERENCE TO SEQUENCE LISTING, A TABLE, OR A COMPUTER PROGRAM LISTING COMPACT DISC APPENDIX

“not applicable”

### BACKGROUND OF THE INVENTION

The present invention relates generally but not specifically to door locking devices and, more particularly, to an improved door restraining assembly designed for doors that have a surrounding doorframe mounted within a reinforcement support system that surrounds the doorframe and also supports the frame of an accompanying window commonly known as a sidelight with the support feeing of varying widths, and the sidelight being on am or both sides of the door, commonly but not necessarily known as a Pre-Hung Door with Sidelight assembly; and also a method of installation. The present invention is an improvement on this inventors U.S. Pat. No. 5,769,473 filed May 8, 1997, dated Jun. 23, 1998 called APPARATUS FOR DOOR RESTRAINING ASSEMBLY. In as much as the first Patent is designed for doorframes mounted in a building structure which is commonly made of a wood stud construction, the present invention is designed to reinforce a doorframe that is mounted in a framework support assembly commonly referred to as a Door with Sidelight Assembly. U.S. Pat. No. 5,769,473 is restricted from use in a Poor with Sidelight Assembly because the framework support of a Door with Sidelight Assembly is most often forward or backward of the alignment position of the door jamb and the support most generally creates only a short distance from the doorframe and the adjacent sidelight glass.

The present invention is installed behind a normal striker plate, be it for a Deadbolt or Door Latch, and has a receiving member that accepts the Deadbolt or Door Latch plunger, with a reduced diameter extension shortened, compared to that of the previous patent, that is purposely tubular to accept a fastening screw for securing the receiving member in position and allows for the receiving member to be rotated to allow positioning within the most central portion of the support framework.

On the hinge side of the door, a similar receiving member is installed through the doorframe and into the reinforcement support in a similar fashion and is designed to accept a male pin member that is secured to and projects from the hinge side edge of the door and seats within the receiving member when the door is rotated to a closed position.

### DESCRIPTION OF THE PRIOR ART

Locking devices and assemblies for use with doors are constantly being developed and improved to prevent an intruder from breaking into a home or business. In as much as the present invention is an improvement on this inventors original U.S. Pat. No. 5,789,473 it is understood the prior art descriptions are in direct alignment with the prior Patent. Improvements on the prior Patent will be discussed in the Detailed Description of the Invention.

If U.S. Pat. No. 6,837,527 issued to Laurenzana teaches a striker plate that is comprised of the visible plate with a cylindrical tubing extension. This invention requires drilling a large hole through the doorframe straight into the studs of a building. As is commonly known in the art of door reinforcement installation, the relationship of the doorframe to the studs would enable this large bole to break through the side of the studs and cot into the drywall or other surface of the interior of the building. This would render the invention useless, but also in the instance of the style of doors with sidelights, would normally break through the wood framework supporting the doorframe and sidelight window. This would not only be unacceptable to the building owner, but also weaken the structure rather than reinforce it.

U.S. Pat. No. 7,003,992 issued to Scribner teaches, first, a mechanism on the hinge side that requires an operator to use a key to slide a hidden rod inside the door to engage through the hinge into the framework. The hole is also in line with the drywall or interior sheeting of the building similar to Laurenzana's U.S. Pat. No. 6,837,527. Second in Scribner's claim is a similar pin on the doorknob side that operates in the same fashion as standard Deadbolts common in the industry. The receptacle for the plunger goes straight into the doorframe stowing for the same break-through into the sheeting as described on the hinge side.

U.S. Pat. No. 5,906,404 issued to McGee teaches a threaded cylindrical receiver that, by design, would fee installed in doorframes that are installed in 2×4 constructed buildings and is of sufficient length to penetrate both 2×4 studs. This would also allow for breaking into the inside sheeting of the building since it is drilled perpendicular to the face of the doorframe, and as mentioned before would break through the surrounding frame of a door with sidelight glass that, by design, does not have 2×4 studs.

U.S. Pat. No. 5,769,473 issued to this applicant end of which this is an improvement to said Patent, teaches receptacles that have a smaller extension that extend axially from the receptacle socket in a determined angle. What will be shown in the Detailed Description of the Invention is that the existing extensions are reduced in length and are hollow in design to accept a mounting screw of determined length. This allows for use in doors with sidelight glass that are installed in frameworks that, by design, are not in alignment with the doorframe and do not have sufficient distance to accept the longer axial extension required in doors installed in 2×4 rough openings.

U.S. Pat. No. 5,724,705 issued to Hauser teaches an interlocking assembly on the hinge side that is conical by design and only enters the doorframe for reinforcement. It shows no tie into the adjoining studs or framework of the building.

U.S. Pat. No. 4,186,954 issued to Detlefs teaches only a Deadbolt reinforcement cavity with a reduced pin extension that extends only perpendicular from the box that is the receptacle of the invention. This extension, by design, is of sufficient length to penetrate the two studs of the building after clearing the gap between the doorframe and studs. This would allow for breaking through fee support framework of a door with sidelight glass.

U.S. Pat. No. 3,970,340 issued to Taft teaches a pin extension for the hinge side only. By design the pin extension is driven in perpendicular to the face of the doorframe. Similar to previous patents mentioned before this allows for breaking through into the reinforcement of the doorframe. No attention is given to the Deadbolt side of the door.

### REFERENCES CITED

| | | |
|---|---|---|
| 6,837,527 | September 2003 | Laurenzana |
| 7,003,992 | March 2003 | Scribner |
| 5,906,404 | December 1997 | McGee |
| 5,769,473 | May 1997 | Sovis |
| 5,724,705 | May 1996 | Hauser |
| 4,186,954 | September 1977 | Detlefs |
| 3,970,340 | June 1975 | Taft |

### BRIEF DESCRIPTION OF THE DRAWINGS

A better understanding of the present invention will be had upon reference to the attached drawings, when read in combination with the following specification, wherein like reference numerals refer to like parts throughout the several views, and in which:

FIG. 1 is a top view in cutaway of a first restraining assembly located on a hinge side and a second restraining assembly located so a latch side for use with a door and surrounding door jamb according to a preferred embodiment of the present invention;

FIG. 2 is a view of the hinge side mounted restraining assembly as shown in FIG. 1 in which the door and hinge pin are in a partially rotated open position;

FIG. 2a illustrates a method step for installing the receiving member in which a drill forms a hole for the extending tube portion through a guide aperture.

FIG. 3 is a frontal view of the hinge side pin member according to the present invention;

FIG. 3a is a side view cutaway of the hinge side pin member according to the present invention;

FIG. 4 is a perspective view of the hinge side receiving member shown from the side that first enters an aperture in the door jamb;

FIG. 4a is a perspective view of the hinge side receiving member shown from the side that accepts the hinge side pin member as the door is closed.

FIG. 5 is a side cutaway of the hinge side receiving member according to the present invention.

FIG. 6 is a common blind hole transfer punch used to create a definite alignment between the apertures drilled into the door edge and doorframe.

FIG. 7 is a perspective view of the hinge side elongated disc-shaped template for gauging the alignment and direction of the reduced diameter aperture for the receiving member, viewing from the exposed side that accepts the drill first.

FIG. 7a is a perspective view of the hinge side elongated disc-shaped template for gauging the alignment and direction of the reduced diameter aperture for the receiving member, viewing from the side that enters the aperture first.

FIG. 8 is a perspective view of the latch side receiving member shown from the side that enters the aperture first on the latch side of the doorframe.

FIG. 8a is a perspective view of the latch side receiving member shown from the side that accepts the protruding member of a standard deadbolt or door knob assembly.

FIG. 9 is a perspective view of the latch side elongated rectangular template for gauging the alignment and direction of the reduced diameter aperture for accepting the latch side receiving member viewed from the exposed side that accepts the drill first.

FIG. 9a is a perspective view of the latch side elongated rectangular template for gauging the alignment and direction of the reduced diameter aperture for accepting the latch side receiving member viewed from the side that enters the aperture first.

FIG. 10 is a view of a guide plate that is temporarily mounted in place of a conventional striker plate on a latch side of a doorframe that describes the rectangular perimeter needed to drill or route the aperture needed for accepting the rectangular template for drilling the reduced diameter aperture and thus the receiving member of the latch side.

### DETAILED DESCRIPTION OF THE INVENTION

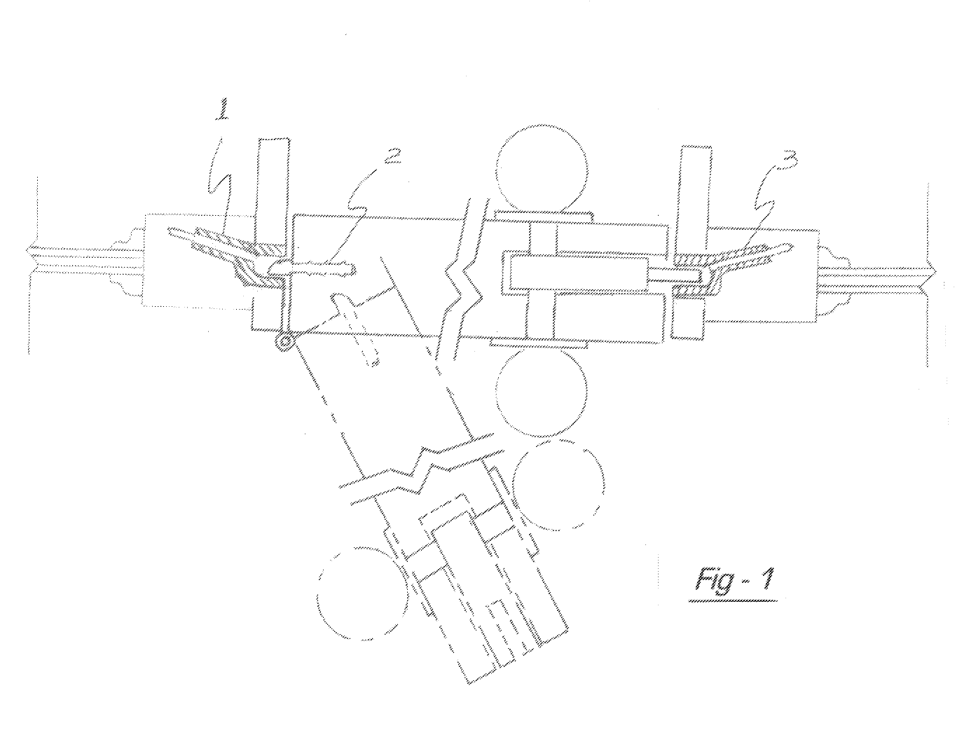

Referring now to FIG. 1 a restraining assembly is shown with a door hingedly connected to a doorframe mounted with a support framework that also supports a sideglass window framework. Member 1 is mounted within the doorframe and adjacent support of the assembly on the hinge side of the door, and member 2 is mounted within the door on the hinge side edge. Similarly, member 3 is mounted within the doorframe and adjacent support on the latch side of the door to accept the plunger of a Deadbolt or latch mechanism.

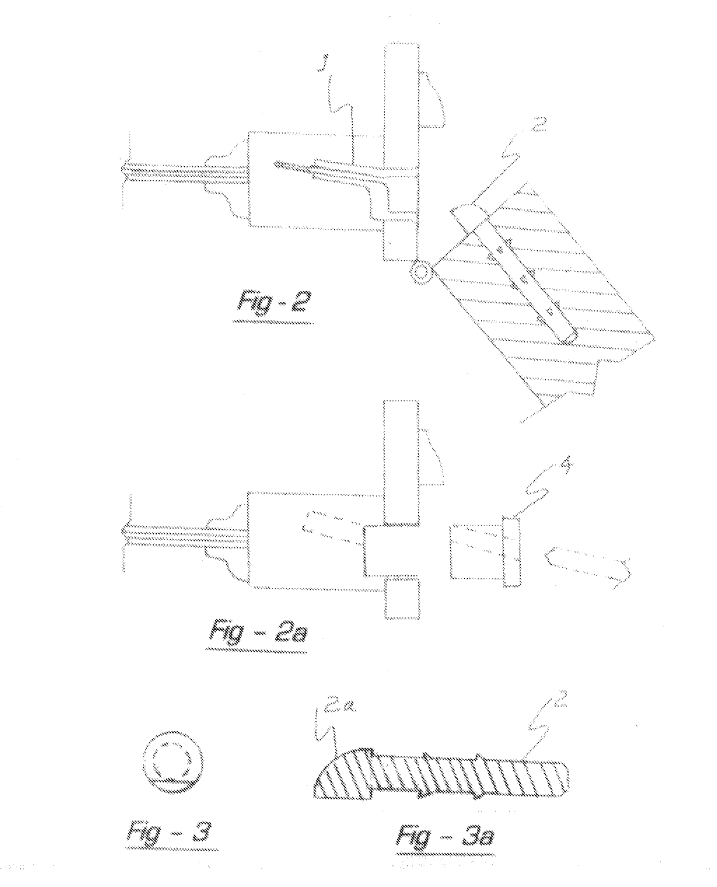

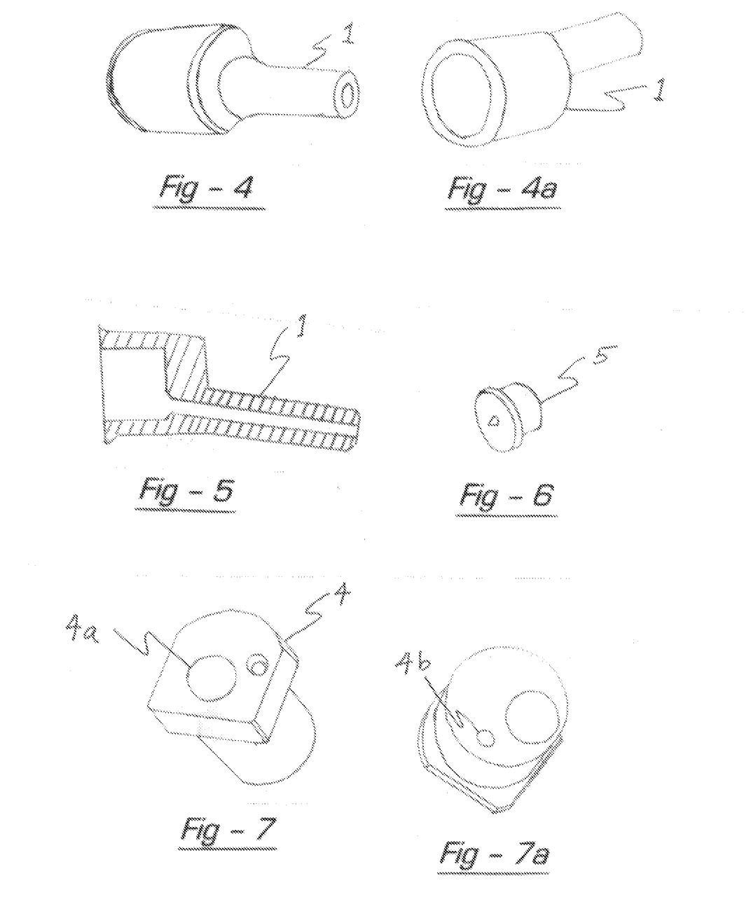

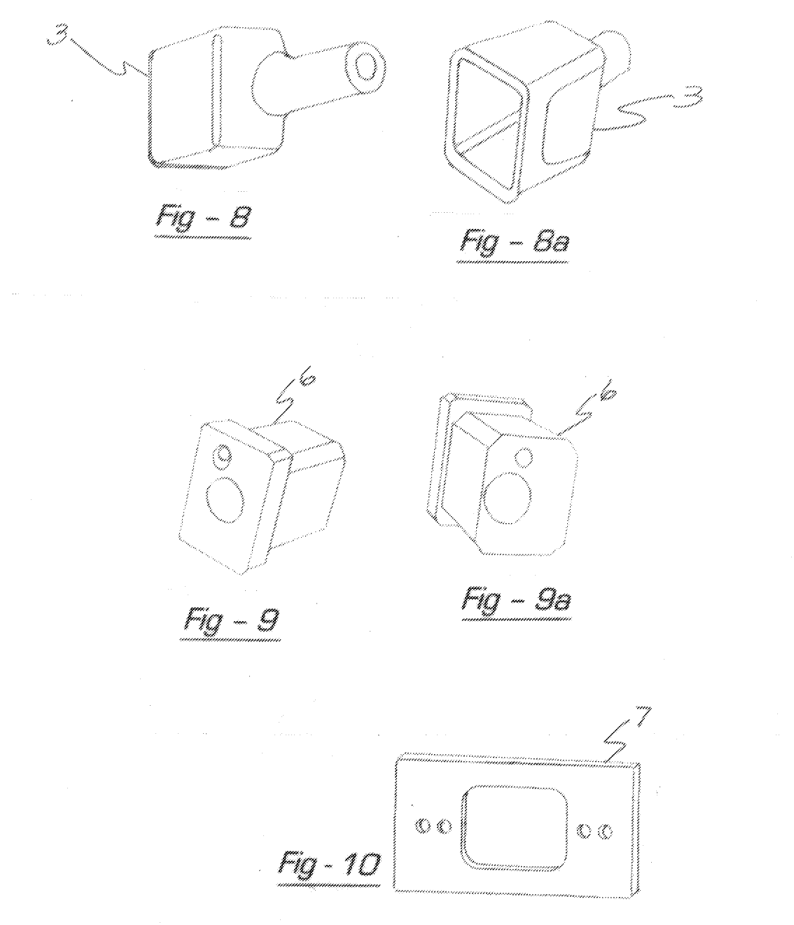

Referring now to FIG. 2 a more detailed view of the hinge side mechanism is shown as member 2 would enter member 1. Referring to FIG. 2a, member 4 is shown as it is temporarily installed in the doorframe used as a guide to align a drill or similar tool to create the aperture for proper alignment for installation of member 1. FIGS. 3 and 3a show frontal and side views of member 2 which will be installed into the door edge on the hinge side. FIGS. 4 and 4a show perspective views of member 1 to clarify the position of its components. FIG. 5 shows a cross-section of member 1 for clarity of the inner dimensions. FIG. 6 shows member 5, a standard blind hole transfer punch that is used in the installation to align the apertures that contain members 1 and 2. FIGS. 7 and 7a show perspective views of member 4 to explain the guide holes used for drilling the aperture to accept member 1. FIGS. 8 and 8a show perspective views of member 3 to give a more detailed view of the position of its components. FIGS. 9 and 9a show perspective views of drill guide member 6 used for the alignment of the aperture needed for member 3. FIG. 10 shows template member 7 which is used to decipher the position of the aperture needed to first install drill guide member 6 and subsequently member 3.

The method for installation begins with locating the proper position on the hinge side edge of the door to install male pin member 1 and drilling the appropriate size and depth of hole. In the hole blind hole transfer member 5 is temporarily installed and the door is closed to transfer a center mark into the doorframe. Once marked member 5 can be removed. In the position created by the center mark an aperture is drilled to accept member 4 that will guide the drill used for drilling the reduced diameter of member 1. Member 4 is installed and secured by a fastener installed in member 4b shown in FIG. 7a. The depth of the aperture is determined by the length of the reduced diameter portion of member 1. Once the hole is drilled using the drill guide member 4, it is removed and member 1 is installed and secured with an appropriate fastener allowing for as much entry into the support framework without breaking through to the sidelight glass. Member 2 is then installed into the aperture drilled into the door edge making sure to align the surface member 2a to clear properly while closing the door. The installation for receiving portion member 3 is accomplished by temporarily removing the striker plate behind which member 1 will be installed whether it be for a Deadbolt or Door latch. In its place Template member 7 is temporarily installed and the center rectangular area is traced unto the doorframe. The template member 7 is then removed and the marked area is removed to the appropriate depth by use of standard doling or routing equipment. Once removed drill guide member 6 is temporarily installed and secured and the aperture is drilled for the reduced diameter of member 3. The aperture depth is equal to the length of the reduced diameter extension of member 3. Once drilled the drill guide member 6 is removed and member 3 is installed and secured with an appropriate fastener allowing for as much entry into the support framework without breaking through to the sidelight glass. The original striker plate is then reinstalled to cover member 3.

The present invention therefore discloses a restraining assembly in which the resiliency of the support framework of a system that is commonly referred to as a Door with Sidelights Assembly is incorporated into supporting the doorframe and door to prevent forced entry.

Having described my invention, additional embodiments will become apparent to those skilled in the art to which it pertains without deviating from the scope of the claim. I claim:

1. A restraining assembly for use in combination with a door hingedly connected to a surrounding doorframe within a framework that generally but not specifically encompasses a framework for adjacent windows commonly referred to as sidelights, where at least one pin member having a body and an axially extending seating portion is recessed within the edge of the hinge side of the door end a receiving member projects laterally from the door in a direction toward and through the associated doorframe and into the adjacent framework having a length allowing for installation in the support framework without breaking through the opposite end and secured by a fastener of determined length so as to benefit from as much of the framework as available. Similarly on the latch side of the door, a receiving member is installed behind a normal striker plate to accept a plunger from either a Deadbolt or Door latch mechanism and installed in a similar manner as on the hinge side, to benefit from as much of the surrounding framework as possible.

2. I claim the ability of the receiving: members to rotate to benefit from entering as close to the center of the adjacent framework support to add as much strength as possible.

3. I claim the method of installation which will position the restraining assemblies at the most opportune position and alignment possible.
